(19) United States
(12) Patent Application Publication
(10) Pub. No.: US 2015/0163110 A1
(43) Pub. Date: Jun. 11, 2015

(54) Registration Reconciliation Influenced by Expired Registration Records

(71) Applicant: International Business Machines Corporation, Armonk, NY (US)

(72) Inventors: Leonardo F. Demo, Sao Paulo (BR); Denilson Nastacio, Apex, NC (US); Paulo H. Sousa Leal, Sao Paulo (BR)

(73) Assignee: International Business Machines Corporation, Armonk, NY (US)

(21) Appl. No.: 14/101,794

(22) Filed: Dec. 10, 2013

(51) Int. Cl. H04L 12/26

(52) U.S. Cl. CPC H04L 43/08

(57) ABSTRACT

An approach is provided in which a registry service system correlates multiple registration records, one of which is expired, to a network resource. The registry service system generates a quality of correlation value based upon registration record confidences corresponding to the correlated registration records. In turn, the registry service system creates a resource record that includes the quality of correlation value and indicators corresponding to the correlated registration records.

### BACKGROUND

Management solutions are responsible for monitoring a particular computer environment and creating registration records for network resources included in the computer environment (e.g., computer systems, servers, storage systems, network cards, printers, ATM machines, etc.). These registration records typically include network resource information based upon the type of management solution. For example, a hardware inventory management solution may generate a registration record for a computer that includes the computer's model number, manufacturer, and serial number, whereas a network management solution may generate a registration record for the same computer that includes the computer's IP address and MAC address.

Multiple types of management solutions typically monitor a computer environment. As a result, multiple different registration records correspond to a single network resource. The corresponding registration records may have one or more intersecting resource attributes, such as a serial number or host name. For example, a computer may have three corresponding registration records, one of which includes the computer's hostname and model/manufacturer/serial number; the second of which includes the computer's host name; and the third of which includes the computer's model/manufacturer/serial number.

Management solutions typically store the registration records in a storage area and update the registration records as needed up until the registration records' expiration time. When a registration record reaches its expiration time, the registration record is removed from the storage area.

### BRIEF SUMMARY

According to one embodiment of the present disclosure, an approach is provided in which a registry service system correlates multiple registration records, one of which is expired, to a network resource. The registry service system generates a quality of correlation value based upon registration record confidences corresponding to the correlated registration records. In turn, the registry service system creates a resource record that includes the quality of correlation value and indicators corresponding to the correlated registration records.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing one embodiment of a registry service system managing registration records generated from different management solutions;

FIG. 2 is a detail diagram showing a registry service system managing resource records that correlate multiple registration records;

FIG. 3 is a diagram showing a conceptual representation of the differences between registration records and resource records;

FIG. 4 is a diagram showing relationships between different registration records and corresponding reconciliation formulas to compute a quality of correlation;

FIG. 5 is a diagram showing a relationship between three registration records and registration record information;

FIG. 6 is a flowchart showing one example of steps taken by a registry service system to manage registration records and resource records;

FIG. 7 is a flowchart showing one example of steps taken by a registry service system's reconciliation module to reconcile registration records;

FIG. 8 is a flowchart showing one example of steps taken by a registry service system to track registration record expirations and record lifetimes;

FIG. 9 is a block diagram of a data processing system in which the methods described herein can be implemented; and

FIG. 10 provides an extension of the information handling system environment shown in FIG. 9 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following detailed description will generally follow the summary of the disclosure, as set forth above, further explaining and expanding the definitions of the various aspects and embodiments of the disclosure as necessary.

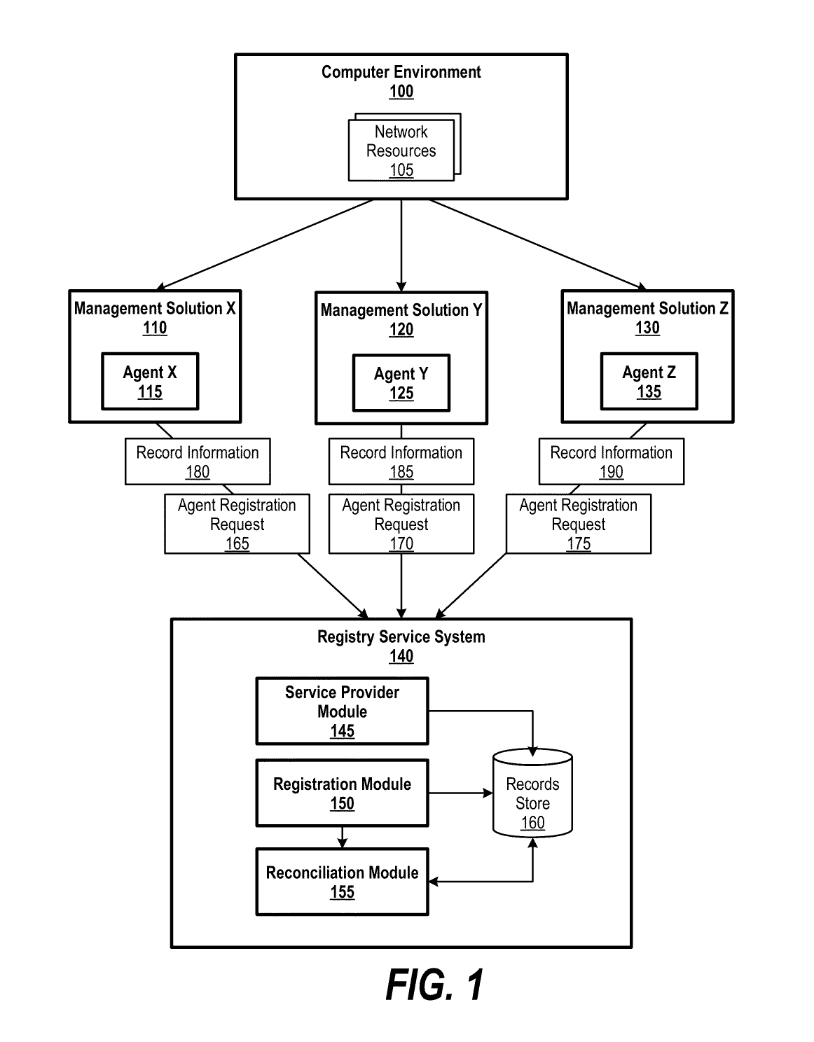

FIG. 1 is a diagram showing one embodiment of a registry service system managing registration records generated from different management solutions. Computer environment 100 includes network resources 105, such as computer systems, network cards, printers, ATM machines, etc. Each of management solutions 110, 120, and 130 monitor computer environment 100 and include agent 115, 125, and 135, respectively. Each of agents 115-135 register with registry service system 140 via agent registrations 165, 170, and 175. In turn, agents 115-135 provide record information 180, 185, and 190 that includes information pertaining to network resources 105 (e.g., serial numbers, host names, IP addresses, etc.).

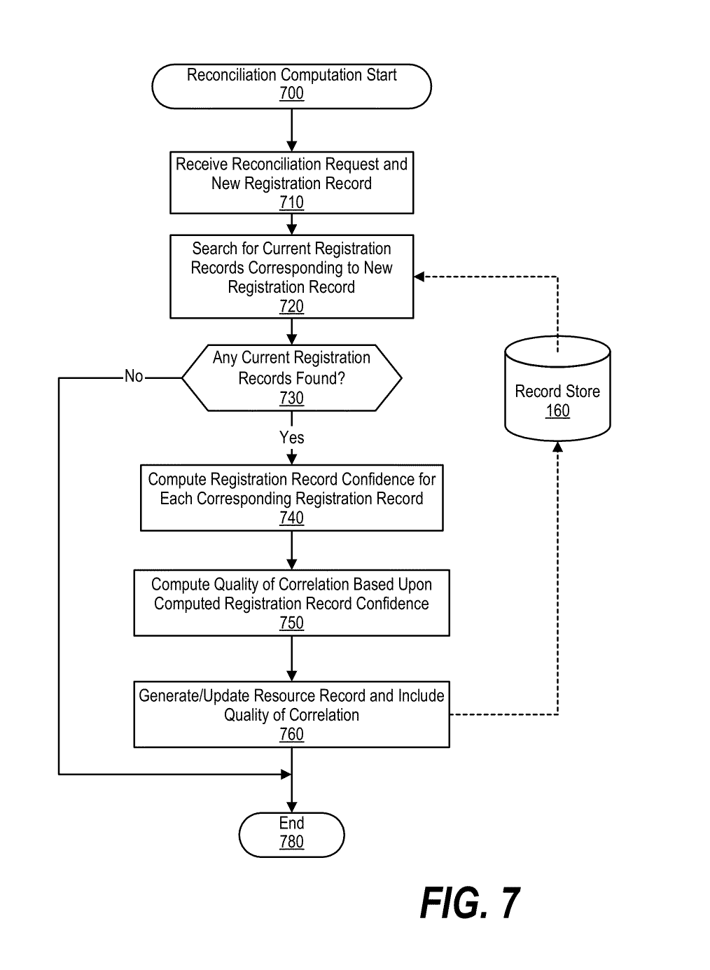

Registry service system 140 includes service provider module 140, which creates agent records in response to receiving agent registration requests 165-175, and stores the agent records on records store 160. Registration module 150 receives record information 180-190 and creates registration records accordingly, which are stored in records store 160. In one embodiment, the registration record includes an expiration time (control expiration time) and a time to live. In another embodiment, registry service system 140 assumes ownership of a registration record when the registration record reaches its expiration time (see FIG. 7 and corresponding text for further details).

When registration module 150 receives a new registration record, registration module 150 sends a reconciliation request to reconciliation module 155. In turn, reconciliation module 155 proceeds through steps to create a resource record that correlates the new registration record to existing registration records (included in records store 160). In addition, in one embodiment, registry service system 140 computes a “Quality Of Correlation” between the registration records included in the same resource record. In this embodiment, registry service system 140 determines a registration record confidence (rrc) of each registration record based upon the registration record's record age (RA), expiration time (ET) and record lifetime (RL), such as with the formula:

Registration Record confidence (rrc)=100% if RA<ET;

100%−(RA/RL) if ET<RA<RL; and

0% if RA≧RL.

Registry service system 140 determines a quality of correlation between two resources “a” and “b” separated by “n” degrees of matching attributes through the formula:

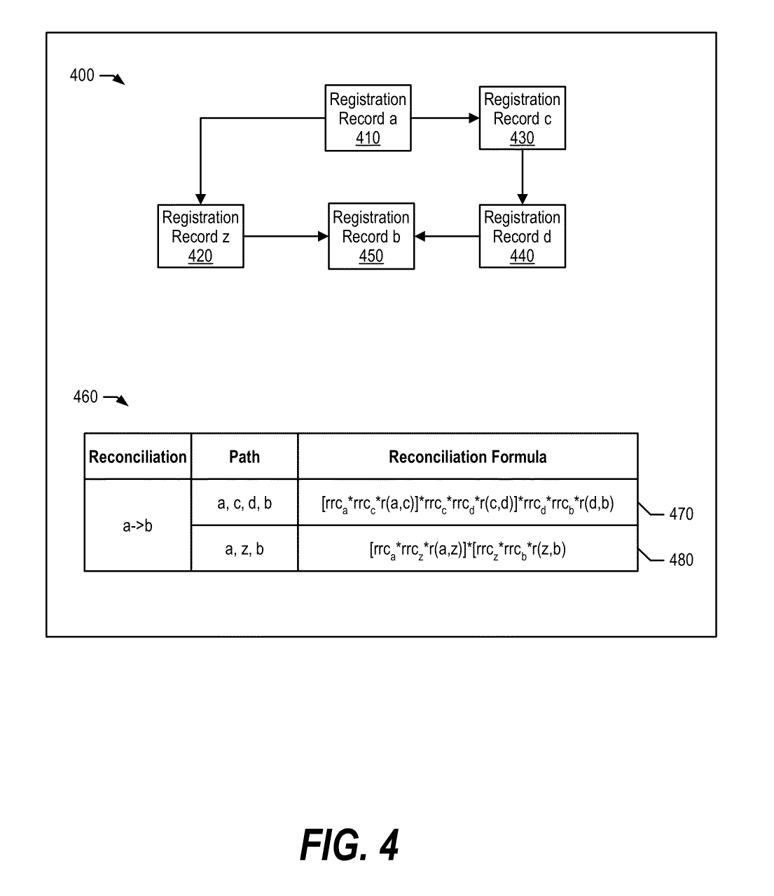

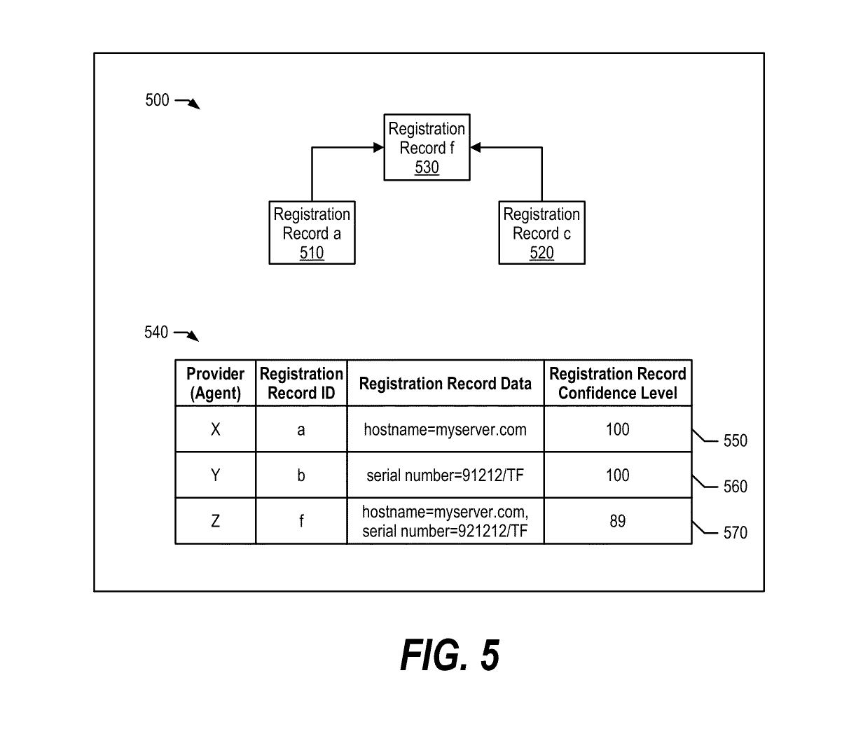

QoC (a,b)=Max (Product (rrcₘ*rrcₙ*r(m,n))),

where “m” and “n” define the endpoints of the relationship paths for a given path “P” linking “a” to “b”, and r(x,y) is the reconciliation strength between resources “x” and “y” given by the above formula (see FIGS. 4, 5, and corresponding text for further details).

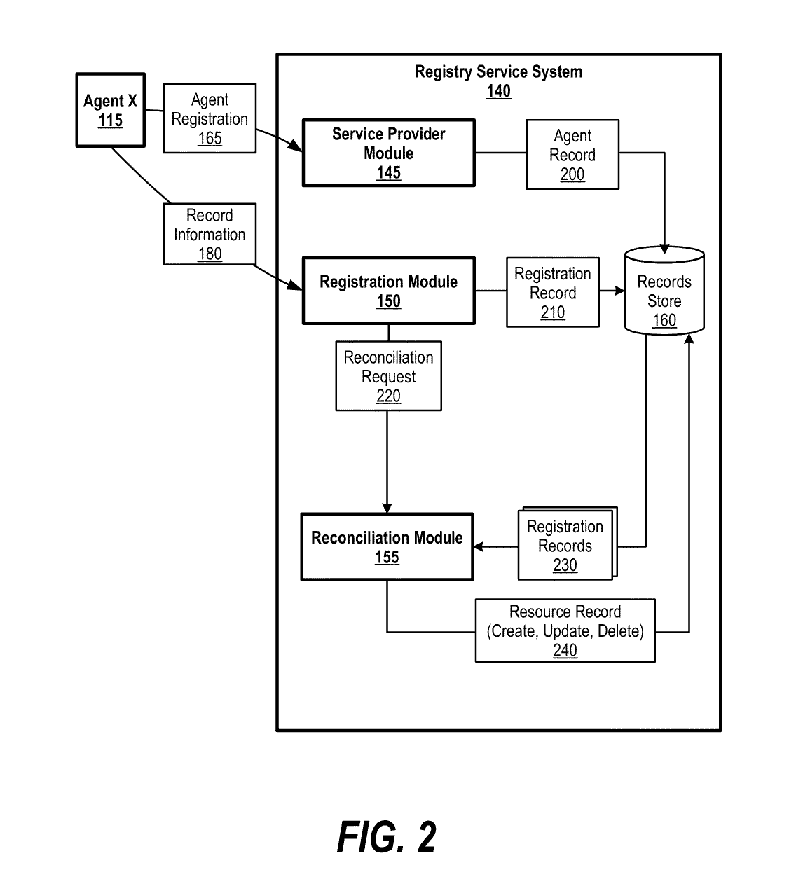

FIG. 2 is a detail diagram showing a registry service system managing resource records that correlate multiple registration records. Service provider module 145 receives agent registration request 165 from agent X 115. In turn, service provider module 145 creates agent record 200 and stores agent record 200 in records store 160, which includes information such an agent's capabilities, locations, and available services.

Once agent X 115 registers with registry service system 140, agent X 115 monitors computer environment and provides record information 180 to registration module 150, which includes information corresponding to a particular network resource. Registration module 150 creates registration record 210 and stores the registration record in records store 160. In addition, registration module 150 sends reconciliation request 220 to reconciliation module 155. Reconciliation request 220 may include registration request 210 and/or a registration identifier that identifies registration record 210 (which reconciliation module 155 uses to retrieve registration record 210 from records store 160).

Reconciliation module 155 receives reconciliation request 220 and searches records store 160 for registration records that include resource attributes corresponding to registration record 210's resource attributes (e.g., matching serial number, etc.). In one embodiment, reconciliation module 155 parses registration record 210 to obtain the resource attributes (e.g., IP address, serial number, host name, etc.) and matches the parsed resource attributes with the registration records included in records store 160.

Reconciliation module 155 identifies corresponding registration records 230 and computes registration record confidences for each corresponding resource record, as well as computing a quality of correlation for the corresponding resource records. In turn, reconciliation module 155 includes the quality of correlation value in a new resource record (includes identifiers for the new registration record and registration records 230), or updates an existing resource record (includes a new registration record identifier in an existing resource record that includes existing registration record identifiers) via resource record 240. As described herein, a quality of correlation value is a percentage value indicating the relative amount of confidence that a resource record is a correct representation of a network resource. As those skilled in the art can appreciate, other approaches may be used to show relative confidences between different resource records.

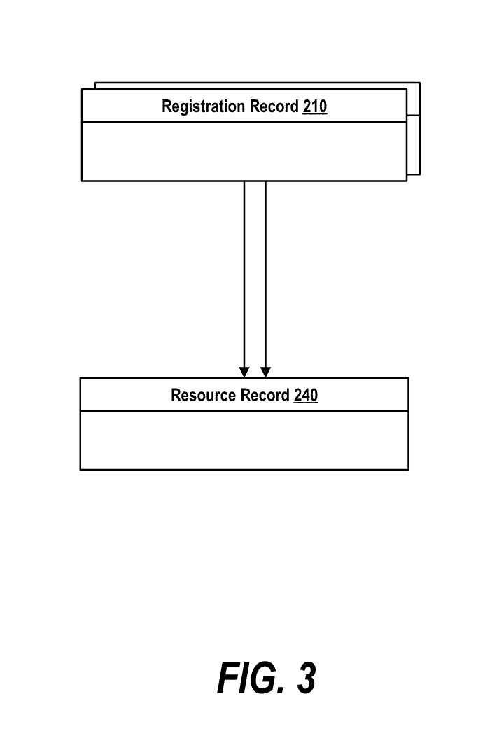

FIG. 3 is a diagram showing a conceptual representation between registration records and resource records. A registration record corresponds to information as received from an agent, whereas a resource record corresponds to a single reconciled (also referred to as correlated) view of registration records from multiple agents. In one embodiment, multiple registration records may be reconciled to a single resource record. In another embodiment, a registration record may be dissociated from a resource record if that registration record fails to meet the criteria of having sufficient attributes to be identified (e.g. the identifier for a particular class of records is comprised of three attributes but a corresponding agent did not provide the three attributes).

FIG. 4 is a diagram showing relationships between different registration records and corresponding reconciliation formulas to compute a quality of correlation. Diagram 400 shows two reconciliation paths between registration record a 410 and registration record b 450. The first path includes registration record z 420 and the second path includes registration record c 430 and registration record d 440.

As such, QoC(a,b) is defined by a highest value of (Product (rrcₘ*rrcₙ*r(m,n))) for each path. Table 460 includes two formulas for the two different paths. Entry 470 includes the formula:

[rrcₐ*rrc_{c}*r(a,c)]*[rrc_{c}*rrc_{d}*r(c,d)]*[rrc_{d}*rrc_{b}*r(d,b)]

and entry 480 includes the formula:

[rrcₐ*rrc_{z}*r(a,z)]*[rrc_{z}*rrc_{b}*r(z,b)].

As such, registry service system 140 inputs registration record confidence (rrc) values into their corresponding variable locations to compute two quality of correlation values and, in turn, selects the highest quality of correlation value.

FIG. 5 is a diagram showing a relationship between three registration records and registration record information. Diagram 500 shows a relationship between registration record a 510, registration record c 520, and registration record f 530. Table 540 includes three registration records that include a provider of the registration information (management solution), a registration record identifier, registration record data, and a computed registration record confidence level using the formula:

Registration Record confidence (rrc)=100% if RA<ET; (RA=Record Age, ET=Expiration Time) 100%−(RA/RL) if ET<RA<RL; and (RL=Record Lifetime) 0% if RA≧RL.

Entries 550 and 560 show that registration records a 510 and c 520 have not reached expiration (100% confidence level) and registration record f 530 is between its expiration time and record lifetime. As such, using the reconciliation formula as discussed above, the quality of correlation value is:

[rrca*rrcf*r(a,f)]*[rrcf*rrcc*r(f,c)]=[100%*89%*1]*[89%*100%*1]=89%*89%=79.21%

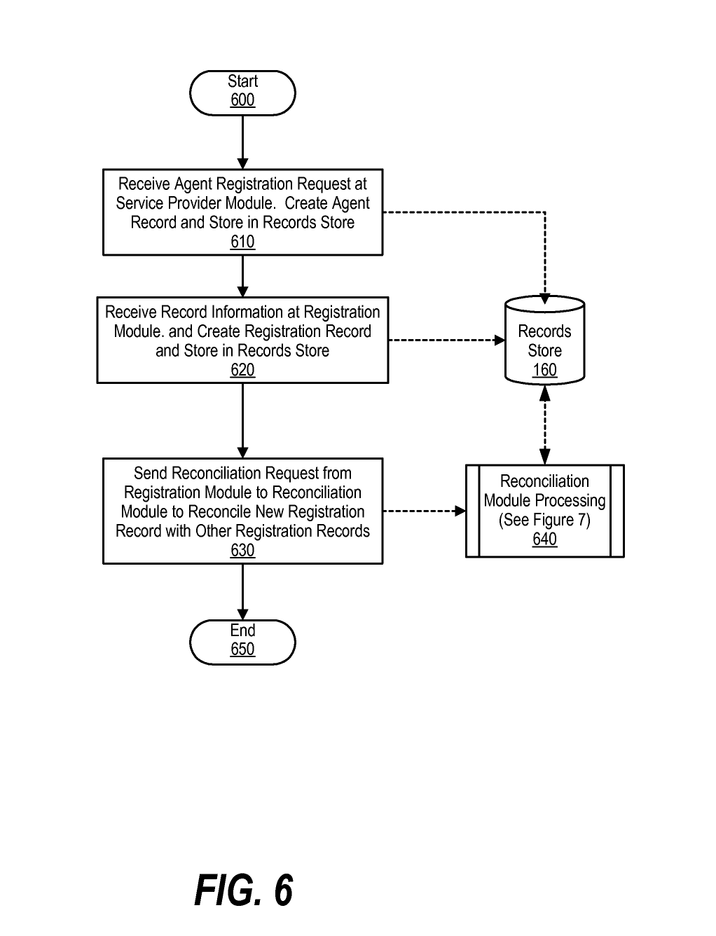

FIG. 6 is a flowchart showing one example of steps taken by a registry service system to manage registration records and resource records. Processing commences at 600, whereupon the registry service system receives an agent registration request from an agent, such as agent X 115 shown in FIG. 1 (610). In turn, the registry service system (service provider module 145) creates an agent record (agent record 200) and stores the agent record in records store 160.

At 620, the registry service system receives record information from the registered agent that identifies a network resource executing on computer environment 100. The registry service system (registration module 150) creates a registration record and stores the registration record in records store 160.

The registry service system's registration module, at 630, sends a reconciliation request to the registry service system's reconciliation module 155. In turn, the reconciliation module generates a reconciliation record that correlates the new registration record with existing registration records in records store 160 (pre-defined process block 640, see FIG. 7 and corresponding text for further details) and computes a quality of correlation between the corresponding registration records. Processing ends at 650.

FIG. 7 is a flowchart showing one example of steps taken by a registry service system's reconciliation module to reconcile registration records. Processing commences at 700, whereupon the reconciliation module receives a new registration request (includes a new registration record) from registration module 150 (710). At 720, the reconciliation module searches records store 160 for existing registration records that correspond to the new registration record. In one embodiment, the reconciliation module parses resource attributes included in the registration record (e.g., IP address, serial number, host name, etc.) and matches the parsed resource attributes with resource attributes included in the existing registration records.

A determination is made as to whether any existing registration records include resource attributes that match to the new registration record's resource attributes, such as a matching serial number (decision 730). If records store 160 does not include a corresponding registration record, decision 730 branches to the “No” branch, bypassing correlation steps. On the other hand, if records store 160 includes one or more corresponding registration records, decision 730 branches to the “Yes” branch, whereupon the reconciliation record computes a registration record confidence for each identified corresponding registration record (740) (see FIG. 5 and corresponding text for further details).

At 750, the reconciliation module computes a quality of correlation based upon the computed registration record confidences, such as that shown in FIG. 4. The reconciliation module, at 760, creates a new resource record (or updates an existing resource record) that includes identifiers for the correlated registration records as well as a quality of correlation value. Processing ends at 780.

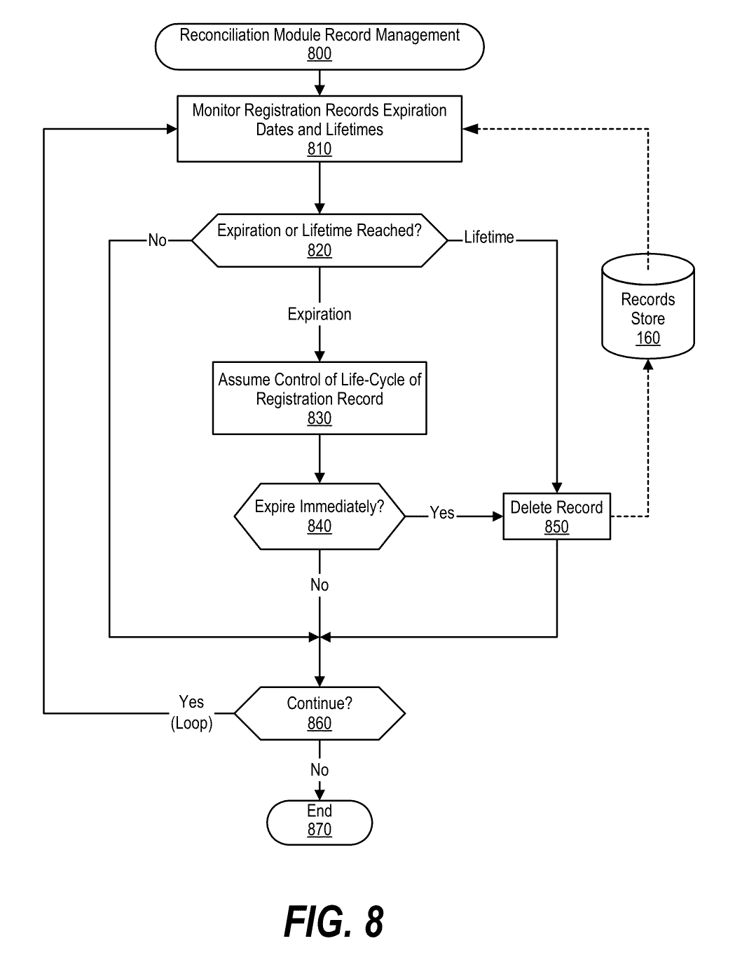

FIG. 8 is a flowchart showing one example of steps taken by a registry service system to track registration record expirations and record lifetimes. Processing commences at 800, whereupon the registry service system searches the registration records included in records store 160 for registration records reaching expiration times and/or record lifetimes (810). The registry service system determines whether any registration records have expired or reached their record lifetime (decision 820). If no registration records have expired or reached their record lifetime, decision 820 branches to the “No” branch, bypassing registration control changing/record deletion steps.

On the other hand, if the registry service system locates a registration record that has reached its record lifetime, decision 820 branches to the “Lifetime” branch, whereupon the registry service system deletes the record from records store 160 at 850. If the registry service system locates a registration record that has reached its expiration time, decision 820 branches to the “Expiration” branch, whereupon the registry service system assumes control (from the corresponding agent) of the life-cycle of the registration record (830).

The registry service system determines whether the registration record should be expired immediately (decision 840). If the registration record should expire immediately, decision 840 branches to the “Yes” branch, whereupon the registry service system deletes the registration record from records store 160 at 850. On the other hand, if the registration record should not expire immediately, decision 840 branches to the “No” branch.

A determination is made as to whether the registry service system should continue monitoring registration record expiration/deletion status (decision 860). If the registry service system should continue monitoring registration record status, decision 860 branches to the “Yes” branch, which loops back to continue monitoring the registration records in records store 160. This looping continues until the registry service system should terminate registration record monitoring, at which point decision 860 branches to the “No” branch whereupon processing ends at 870.

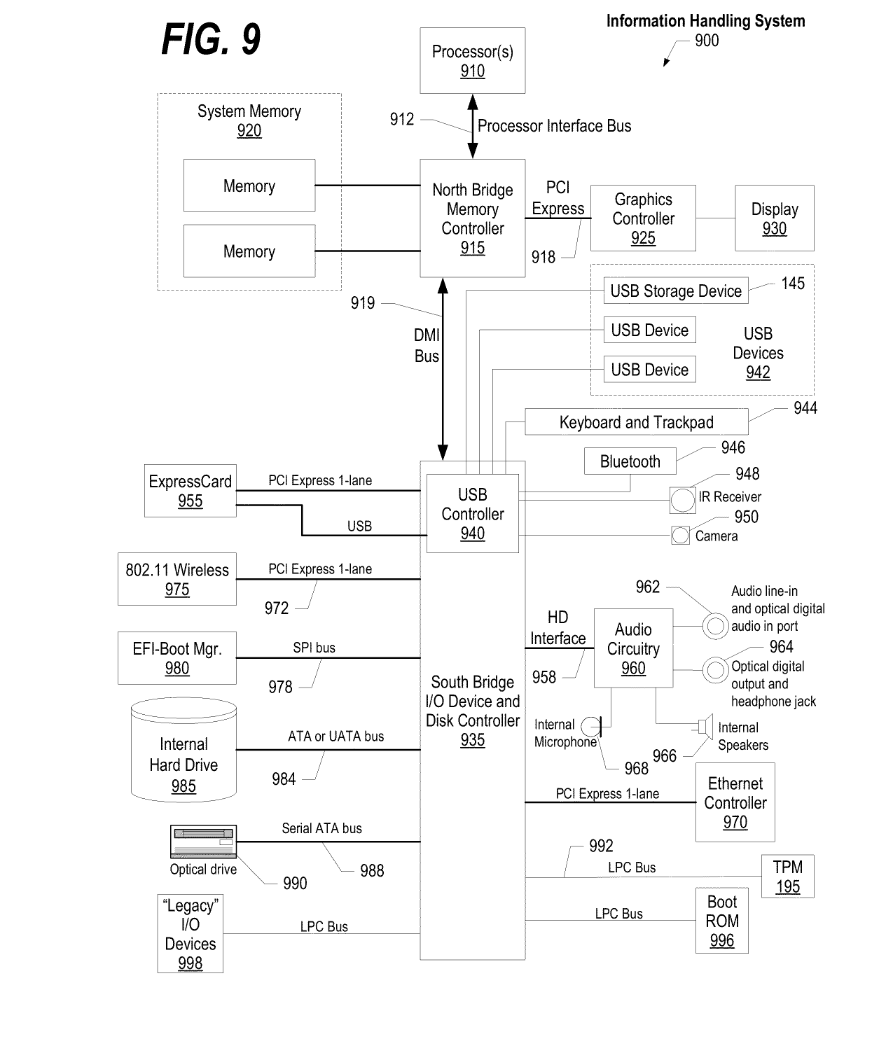

FIG. 9 illustrates information handling system 900, which is a simplified example of a computer system capable of performing the computing operations described herein. Information handling system 900 includes one or more processors 910 coupled to processor interface bus 912. Processor interface bus 912 connects processors 910 to Northbridge 915, which is also known as the Memory Controller Hub (MCH). Northbridge 915 connects to system memory 920 and provides a means for processor(s) 910 to access the system memory. Graphics controller 925 also connects to Northbridge 915. In one embodiment, PCI Express bus 918 connects Northbridge 915 to graphics controller 925. Graphics controller 925 connects to display device 930, such as a computer monitor.

Northbridge 915 and Southbridge 935 connect to each other using bus 919. In one embodiment, the bus is a Direct Media Interface (DMI) bus that transfers data at high speeds in each direction between Northbridge 915 and Southbridge 935. In another embodiment, a Peripheral Component Interconnect (PCI) bus connects the Northbridge and the Southbridge. Southbridge 935, also known as the I/O Controller Hub (ICH) is a chip that generally implements capabilities that operate at slower speeds than the capabilities provided by the Northbridge. Southbridge 935 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 996 and “legacy” I/O devices (using a “super I/O” chip). The “legacy” I/O devices (998) can include, for example, serial and parallel ports, keyboard, mouse, and/or a floppy disk controller. The LPC bus also connects Southbridge 935 to Trusted Platform Module (TPM) 995. Other components often included in Southbridge 935 include a Direct Memory Access (DMA) controller, a Programmable Interrupt Controller (PIC), and a storage device controller, which connects Southbridge 935 to nonvolatile storage device 985, such as a hard disk drive, using bus 984.

ExpressCard 955 is a slot that connects hot-pluggable devices to the information handling system. ExpressCard 955 supports both PCI Express and USB connectivity as it connects to Southbridge 935 using both the Universal Serial Bus (USB) the PCI Express bus. Southbridge 935 includes USB Controller 940 that provides USB connectivity to devices that connect to the USB. These devices include webcam (camera) 950, infrared (IR) receiver 948, keyboard and trackpad 944, and Bluetooth device 946, which provides for wireless personal area networks (PANs). USB Controller 940 also provides USB connectivity to other miscellaneous USB connected devices 942, such as a mouse, removable nonvolatile storage device 945, modems, network cards, ISDN connectors, fax, printers, USB hubs, and many other types of USB connected devices. While removable nonvolatile storage device 945 is shown as a USB-connected device, removable nonvolatile storage device 945 could be connected using a different interface, such as a Firewire interface, etcetera.

Wireless Local Area Network (LAN) device 975 connects to Southbridge 935 via the PCI or PCI Express bus 972. LAN device 975 typically implements one of the IEEE 802.11 standards of over-the-air modulation techniques that all use the same protocol to wireless communicate between information handling system 900 and another computer system or device. Optical storage device 990 connects to Southbridge 935 using Serial ATA (SATA) bus 988. Serial ATA adapters and devices communicate over a high-speed serial link. The Serial ATA bus also connects Southbridge 935 to other forms of storage devices, such as hard disk drives. Audio circuitry 960, such as a sound card, connects to Southbridge 935 via bus 958. Audio circuitry 960 also provides functionality such as audio line-in and optical digital audio in port 962, optical digital output and headphone jack 964, internal speakers 966, and internal microphone 968. Ethernet controller 970 connects to Southbridge 935 using a bus, such as the PCI or PCI Express bus. Ethernet controller 970 connects information handling system 900 to a computer network, such as a Local Area Network (LAN), the Internet, and other public and private computer networks.

While FIG. 9 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

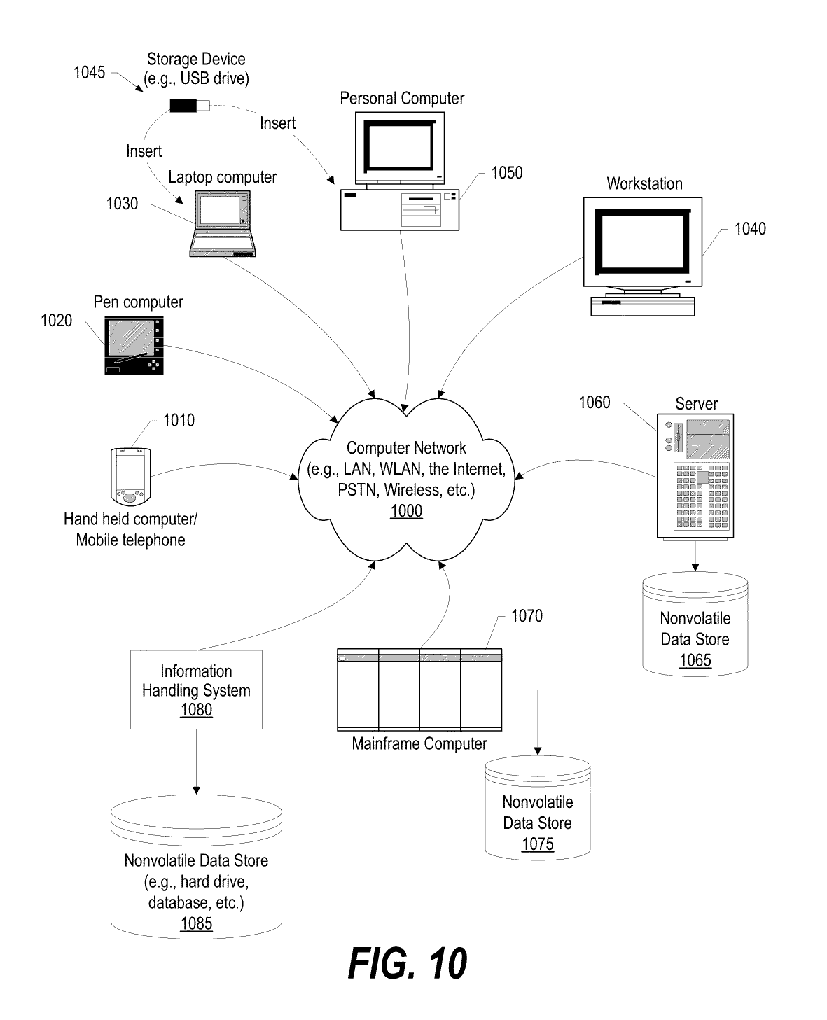

The Trusted Platform Module (TPM 995) shown in FIG. 9 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 10.

FIG. 10 provides an extension of the information handling system environment shown in FIG. 9 to illustrate that the methods described herein can be performed on a wide variety of information handling systems that operate in a networked environment. Types of information handling systems range from small handheld devices, such as handheld computer/mobile telephone 1010 to large mainframe systems, such as mainframe computer 1070. Examples of handheld computer 1010 include personal digital assistants (PDAs), personal entertainment devices, such as MP3 players, portable televisions, and compact disc players. Other examples of information handling systems include pen, or tablet, computer 1020, laptop, or notebook, computer 1030, workstation 1040, personal computer system 1050, and server 1060. Other types of information handling systems that are not individually shown in FIG. 10 are represented by information handling system 1080. As shown, the various information handling systems can be networked together using computer network 1000. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 10 depicts separate nonvolatile data stores (server 1060 utilizes nonvolatile data store 1065, mainframe computer 1070 utilizes nonvolatile data store 1075, and information handling system 1080 utilizes nonvolatile data store 1085). The nonvolatile data store can be a component that is external to the various information handling systems or can be internal to one of the information handling systems. In addition, removable nonvolatile storage device 945 can be shared among two or more information handling systems using various techniques, such as connecting the removable nonvolatile storage device 945 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method comprising:
correlating a plurality of registration records to a network resource, wherein one of the plurality of registration records is an expired registration record;
generating a quality of correlation value based upon a plurality of registration record confidences corresponding to the correlated plurality of registration records; and
creating a resource record that includes the quality of correlation value and one or more indicators corresponding to the plurality of registration records.

2. The method of claim 1 wherein the quality of correlation value corresponds to an amount of confidence that the resource record is a correct representation of the network resource.

3. The method of claim 1 wherein each of the plurality of registration records correspond to a different one of a plurality of management solutions that each monitor the network resource, and wherein each of the plurality of registration record confidences is based upon a control expiration time of one of the plurality of management solutions.

4. The method of claim 1 further comprising:
receiving an agent registration request from an agent that monitors the network resource;
generating a new registration record in response to receiving the agent registration request;
determining that the new registration record corresponds to the network resource;
generating an updated quality of correlation value based upon the plurality of registration record confidences and a new registration record confidence corresponding to the new registration record; and
updating the resource record with the updated quality of correlation value.

5. The method of claim 4 further comprising:
computing a subsequent registration record confidence of the expired registration record based upon a current time and a control expiration time of the expired registration, wherein the subsequent registration record confidence is greater than zero percent and less than one hundred percent; and
utilizing the subsequent registration record during the generation of the updated quality of correlation value.

6. The method of claim 1 further comprising:
identifying a plurality of reconciliation paths between a first one of the plurality of registration records and a second one of the plurality of registration records;
computing a first quality of correlation value based upon a first one of the plurality of reconciliation paths and computing a second quality of correlation value based upon a second one of the plurality of reconciliation paths;
determining that the first quality of correlation value is more than the second quality of correlation value; and
using the first quality of correlation value as the quality of correlation value included in the resource record.

7. The method of claim 6 wherein the first reconciliation path corresponds to the expired registration record and the second reconciliation path corresponds to a different expired registration record that has been expired longer than the expired registration record.

8. An information handling system comprising:
one or more processors;
a memory coupled to at least one of the processors;
a set of computer program instructions stored in the memory and executed by at least one of the processors in order to perform actions of:
correlating a plurality of registration records to a network resource, wherein one of the plurality of registration records is an expired registration record;
generating a quality of correlation value based upon a plurality of registration record confidences corresponding to the correlated plurality of registration records; and
creating a resource record that includes the quality of correlation value and one or more indicators corresponding to the plurality of registration records.

9. The information handling system of claim 8 wherein the quality of correlation value corresponds to an amount of confidence that the resource record is a correct representation of the network resource.

10. The information handling system of claim 8 wherein each of the plurality of registration records correspond to a different one of a plurality of management solutions that each monitor the network resource, and wherein each of the plurality of registration record confidences is based upon a control expiration time of one of the plurality of management solutions.

11. The information handling system of claim 8 wherein the processors perform additional actions comprising:
receiving an agent registration request from an agent that monitors the network resource;
generating a new registration record in response to receiving the agent registration request;
determining that the new registration record corresponds to the network resource;
generating an updated quality of correlation value based upon the plurality of registration record confidences and a new registration record confidence corresponding to the new registration record; and
updating the resource record with the updated quality of correlation value.

12. The information handling system of claim 4 wherein the processors perform additional actions comprising:
computing a subsequent registration record confidence of the expired registration record based upon a current time and a control expiration time of the expired registration, wherein the subsequent registration record confidence is greater than zero percent and less than one hundred percent; and
utilizing the subsequent registration record during the generation of the updated quality of correlation value.

13. The information handling system of claim 8 wherein the processors perform additional actions comprising:
identifying a plurality of reconciliation paths between a first one of the plurality of registration records and a second one of the plurality of registration records;
computing a first quality of correlation value based upon a first one of the plurality of reconciliation paths and computing a second quality of correlation value based upon a second one of the plurality of reconciliation paths;
determining that the first quality of correlation value is more than the second quality of correlation value; and
using the first quality of correlation value as the quality of correlation value included in the resource record.

14. The information handling system of claim 13 wherein the first reconciliation path corresponds to the expired registration record and the second reconciliation path corresponds to a different expired registration record that has been expired longer than the expired registration record.

15. A computer program product stored in a computer readable storage medium, comprising computer program code that, when executed by an information handling system, causes the information handling system to perform actions comprising:
correlating a plurality of registration records to a network resource, wherein one of the plurality of registration records is an expired registration record;
generating a quality of correlation value based upon a plurality of registration record confidences corresponding to the correlated plurality of registration records; and
creating a resource record that includes the quality of correlation value and one or more indicators corresponding to the plurality of registration records.

16. The computer program product of claim 15 wherein the quality of correlation value corresponds to an amount of confidence that the resource record is a correct representation of the network resource.

17. The computer program product of claim 15 wherein each of the plurality of registration records correspond to a different one of a plurality of management solutions that each monitor the network resource, and wherein each of the plurality of registration record confidences is based upon a control expiration time of one of the plurality of management solutions.

18. The computer program product of claim 15 wherein the information handling system performs additional actions comprising:
receiving an agent registration request from an agent that monitors the network resource;
generating a new registration record in response to receiving the agent registration request;
determining that the new registration record corresponds to the network resource;
generating an updated quality of correlation value based upon the plurality of registration record confidences and a new registration record confidence corresponding to the new registration record; and
updating the resource record with the updated quality of correlation value.

19. The computer program product of claim 18 wherein the information handling system performs additional actions comprising:
computing a subsequent registration record confidence of the expired registration record based upon a current time and a control expiration time of the expired registration, wherein the subsequent registration record confidence is greater than zero percent and less than one hundred percent; and
utilizing the subsequent registration record during the generation of the updated quality of correlation value.

20. The computer program product of claim 15 wherein the information handling system performs additional actions comprising:
identifying a plurality of reconciliation paths between a first one of the plurality of registration records and a second one of the plurality of registration records;
computing a first quality of correlation value based upon a first one of the plurality of reconciliation paths and computing a second quality of correlation value based upon a second one of the plurality of reconciliation paths;
determining that the first quality of correlation value is more than the second quality of correlation value; and
using the first quality of correlation value as the quality of correlation value included in the resource record.
